(19) United States
(12) Patent Application Publication
(10) Pub. No.: US 2023/0114614 A1
(43) Pub. Date: Apr. 13, 2023

(54) RELAY APPARATUS, COMMUNICATION APPARATUS, CONTROL METHOD, AND COMPUTER-READABLE STORAGE MEDIUM FOR STREAMLINING PROCESSING FOR CHANGING CONNECTION DESTINATION OF RELAY APPARATUS

(71) Applicant: KDDI CORPORATION, Tokyo (JP)

(72) Inventors: Hiroki TAKEDA, Tokyo (JP); Yanwei LI, Tokyo (JP)

(21) Appl. No.: 18/080,324

(22) Filed: Dec. 13, 2022

Related U.S. Application Data
(63) Continuation of application No. PCT/JP2021/024127, filed on Jun. 25, 2021.

(30) Foreign Application Priority Data
Jun. 26, 2020 (JP) 2020-110810

(51) Int. Cl. H04W 36/38; H04W 36/00

(52) U.S. Cl. CPC H04W 36/38; H04W 36/0079

(57) ABSTRACT

A relay apparatus that relays communication between a base station apparatus and a communication apparatus that is connected to the base station apparatus transmits, in a case where the relay apparatus is connected to another base station apparatus, a message requesting connection with the other base station apparatus, to the communication apparatus.

### CROSS-REFERENCE TO RELATED APPLICATION(S)

This application is a continuation of International Patent Application No. PCT/JP2021/024127 filed on Jun. 25, 2021, which claims priority to and the benefit of Japanese Patent Application No. 2020-110810 filed Jun. 26, 2020, the entire disclosures of which are incorporated herein by reference.

### BACKGROUND OF THE INVENTION

### Field of the Invention

The present invention relates to processing for changing a connection destination of a relay apparatus that relays communication between a base station apparatus and a terminal apparatus.

### Description of the Related Art

In 3rd Generation Partnership Project (3GPP), a technique for applying, to a backhaul link, a method for a terminal apparatus to access a network, and making the method usable has been considered (see 3GPP, TR38.874, V16.0.0, December, 2018). This technique is called “Integrated Access and Backhaul (LAB)”. A relay apparatus called “IAB node” establishes connection to a 5G base station apparatus (IAB donor) using a wireless link, for example. At this time, the IAB node may be directly connected to the IAB donor by establishing a wireless link, or may be indirectly connection to the IAB donor by establishing a wireless link to another IAB node connected directly or indirectly to the IAB donor. At this time, the LAB node functions as a terminal apparatus connected to the base station apparatus, and thereby establishes wireless connection to the above-mentioned other apparatus (upstream apparatus) on the IAB donor side. In addition, after connection to the IAB donor has been established, the IAB node can establish connection to another LAB node or a terminal apparatus that is to be connected to the IAB donor. In this case, the IAB node operates in a similar manner to the base station apparatus, and establishes wireless connection to a terminal apparatus or another IAB node that operates as a terminal apparatus (downstream apparatus). In this manner, the IAB node has a terminal function (MT, Mobile Termination) and a function (DU. Distributed Unit) for performing an operation similar to that of a base station apparatus, and can relay communication between an upstream apparatus and a downstream apparatus using these functions.

In 3GPP release 17, starting consideration on a topology change technique that is accompanied by a switch of an IAB donor, namely a connection partner of an IAB node has been proposed (3GPP, RP-193251, December, 2019). With this technique, when an IAB node installed in a mobile object such as a train or a bus moves, it is possible to maintain communication of the IAB donor itself and communication of another apparatus connected to the IAB donor.

### SUMMARY OF THE INVENTION

The present invention provides a technique for streamlining processing that is performed when an IAB node switches a connection destination thereof, namely an IAB donor.

A relay apparatus according to one mode of the present invention is a relay apparatus that relays communication between a base station apparatus and a communication apparatus that is connected to the base station apparatus, and includes one or more processors; and one or more memories that store a computer-readable instruction for causing, when executed by the one or more processors, the relay apparatus to: transmit, in a case where the relay apparatus fails in a handover from the base station apparatus, and is reconnected to another base station apparatus, a message requesting reconnection with the base station apparatus, to the communication apparatus.

A communication apparatus according to another mode of the present invention includes: one or more processors; and one or more memories that store a computer-readable instruction for causing, when executed by the one or more processors, the communication apparatus to: receive, in a case where a relay apparatus that relays communication between a base station apparatus and the communication apparatus fails in a handover from the base station apparatus, and is reconnected to another base station apparatus, a message requesting reconnection with the other base station apparatus, from the relay apparatus, and execute processing for reconnection to the other base station apparatus via the relay apparatus, based on the message.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an exemplary configuration of a wireless communication system.

FIG. 2 is a diagram showing an exemplary hardware configuration of each apparatus.

FIG. 3 is a diagram showing an exemplary functional configuration of the IAB node.

FIG. 4 is a diagram showing an exemplar functional configuration of a communication apparatus.

FIG. 5 is a diagram showing an exemplary functional configuration of the IAB donor.

FIG. 6 is a diagram showing an example of flow of processing that is executed by a wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

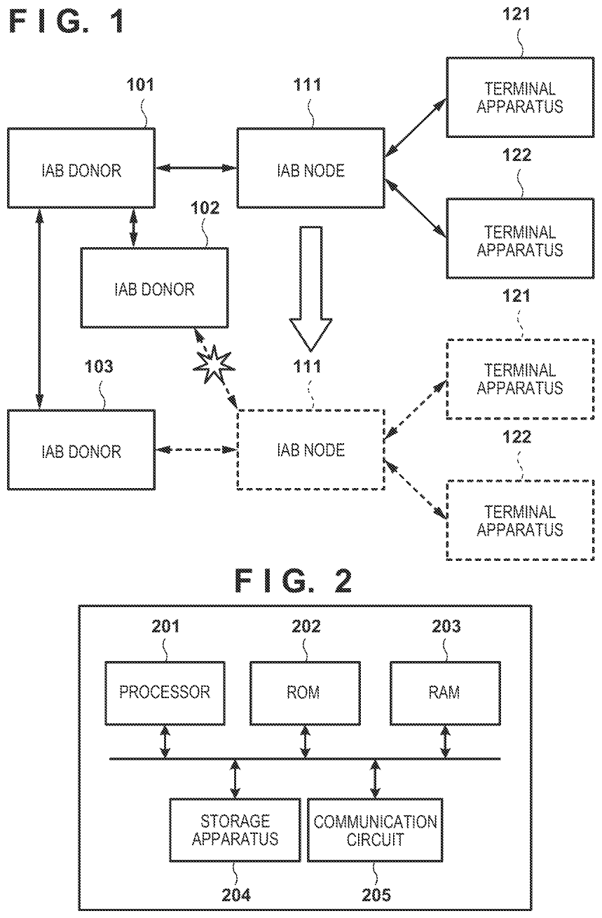

FIG. 1 shows an exemplary configuration of a wireless communication system according to the present embodiment. The wireless communication system according to the present embodiment is a relay transmission system that is based on Integrated Access and Backhaul (IAB) stipulated in 3GPP, and is constituted by an IAB donor 101 and IAB node 111. The IAB node 111 is a relay apparatus that relays communication between the IAB donor 101 and a terminal apparatus 121 or a terminal apparatus 122. That is to say, the terminal apparatus 121 or the terminal apparatus 122 is connected to the IAB donor 101 via the IAB node 111. Note that it may be interpreted that the IAB donor functions as a base station apparatus, and the IAB node functions as a relay apparatus. In the present embodiment, due to movement of the IAB node 111, deterioration in the quality of communication with the IAB donor 101 connected to the IAB node 111, or the like, processing for switching connection to the IAB donor 101 to connection to another IAB donor 102 is executed (a handover is performed).

The terminal apparatus 121 and the terminal apparatus 122 are connected to the IAB donor 101 via the IAB node 111. Therefore, in a case where the IAB node 111 performs a handover to the IAB donor 102, the terminal apparatus 121 and the terminal apparatus 122 also require processing for changing a connection destination. Thus, the IAB donor 101 separately generates a control signal for a handover of the IAB node 111 and control signals for a handover of the communication apparatuses (terminal apparatus or other IAB node) connected downstream of the IAB node 111, and transmits the generated control signals to the IAB donor 102 that is a handover destination. Note that the control signal for a handover of each of the terminal apparatuses (the IAB node 111, the terminal apparatus 121, and the terminal apparatus 122) may include identification information (ID) and the name of the terminal apparatus and information regarding a connection parameter that has been used by the terminal apparatus. Note that this control signal corresponds to a HANDOVER REQUEST message that is transmitted from a base station apparatus that is a handover source to a base station apparatus that is a handover destination, in a conventional method. Note that, having transmitted this control signal, the IAB donor 101 may erase information regarding the IAB node 111, and the communication apparatuses (terminal apparatus or other LAB node) connected downstream of the IAB node 111.

Note that the above-mentioned identification information (ID) can be a ReestabUE-Identity derived (calculated, for example) from Cell Radio Network Temporary Identifier (C-RNTI), or C-RNTI and physical cell ID (physCellid), which is an identifier that is allocated to each of the terminal apparatuses and IAB nodes by the base station apparatus. In addition, if a communication apparatus connected downstream of the IAB node 111 is an IAB node, Global NG-RAN Node ID or IP address allocated to the IAB node (as a 5G wireless access network node) may be used as identification information (ID).

On receiving the control signals for a handover of the IAB node 111 and the terminal apparatuses 121 and 122, the IAB donor 102 that is a handover destination transmits response signals to the control signals, to the IAB donor 101. A response signal here may include, for each of the IAB nodes and terminal apparatuses, information regarding a connection parameter that is to be used after a handover and that is determined, for example, based on a connection parameter that has been used. Note that this response signal corresponds to a Handover Request Acknowledge message that is transmitted from a base station apparatus that is a handover destination to a base station apparatus that is a handover source.

On receiving a response signal, the IAB donor 101 transmits, to the IAB node 111, the control signal for a handover of the IAB node 111 and the control signals for a handover of the communication apparatuses connected downstream of the IAB node 111. Note that, here, a control signal for a handover corresponds to a conventional RRC Reconfiguration message, for example. Here, the control signal for the IAB node 111 may include information indicating that processing (for example, random access processing) for establishing synchronization with the connection destination to which a switch is to be made (IAB donor 102) is necessary.

On the other hand, there is no change in the partner apparatus (for example, the IAB node 111, for the terminal apparatus 121 and the terminal apparatus 122) to which the communication apparatuses connected downstream of the IAB node 111 are directly connected, and thus control signals for these apparatuses may include information indicating that synchronization establishment processing is not necessary. Thus, upon receiving the control signal, each of the communication apparatuses connected downstream of the IAB node 111 transmits a response message (RRC Reconfiguration Complete message) to the IAB node 111 without executing random access processing or the like, and may determine that a handover has been successfully performed, in accordance with receiving a positive response to the response message. At this time, the control signal received via the IAB node 111 includes information regarding a connection parameter for connection to the IAB donor 102, and thus a state is achieved in which each apparatus may determine that connection to the IAB donor 102 has been established.

However, the communication apparatuses connected downstream of the IAB node 111 can maintain connection to the IAB node 111 as is, but there may be cases where the IAB node 111 cannot establish connection to the IAB donor 102. In other words, there may be cases where the IAB node 111 fails in a handover (for example, random access). At this time, the IAB node 111 can establish connection by executing reconnection processing with another IAB donor 103 (or another IAB node that relays communication with the IAB donor). In this case, the IAB donor 103 that is a reconnection destination of the JAB node 111 does not recognize the communication apparatuses connected downstream of the IAB node 111, and the communication apparatuses cannot perform communication from that point on. Thus, the communication apparatuses need to be reconnected to a base station apparatus in order to resume communication. The communication apparatuses execute processing such as cell search again, which requires a long time before resuming communication.

In light of such circumstances, when the IAB node 111 according to the present embodiment fails in a handover, executes reconnection processing with the other IAB donor 103, and successfully establishes connection, the IAB node 111 requests the communication apparatuses connected downstream of the IAB node 111, to execute processing for reconnection to the IAB donor 103. Note that, after connection is established through processing for reconnection to the IAB donor 103, the IAB node 111 executes various types of processing such as establishment of an F1 interface and setting of a relay path in order to operate as a relay apparatus. The IAB node 111 then functions as a portion of a base station apparatus by performing such processing, and forms a cell. The IAB node 111 transmits information for connecting this cell (the IAB donor 103) to the communication apparatuses connected downstream of the IAB node 111, to the communication apparatuses. Accordingly, the communication apparatuses can specify the cell that is a reconnection destination, and execute reconnection processing, without performing cell search.

The IAB node 111 adds identification information of the IAB donor 103, as information that enables reconnection to the IAB donor 103 to be established, to a reconnection request, for example, and transmits the reconnection request to the communication apparatuses. The IAB node 11l may also add identification information of the IAB node 111 (for example, the physical cell ID of the cell formed by the IAB node 111), as the information that enables reconnection to the IAB donor 103 to be established, to the reconnection request, for example, and transmit the reconnection request to the communication apparatuses. Note that the reconnection request may be made using an RRC Release message that includes identification information of the IAB donor 103 and the IAB node 111. The reconnection request may also be made using an RRC message other than the RRC Release message. In addition, if a communication apparatus is an IAB node, the IAB node 111 may transmit, to the communication apparatus, a reconnection request that includes identification information of the IAB donor 103 and the IAB node 111 using a BAP command (Backhaul Adaptation Protocol (BAP) Control PDU). This BAP command may include an RLF indicator indicating that a wireless link between the IAB donor 101 and the JAB node 111 has been disconnected, for example.

Upon receiving the reconnection request, the communication apparatus executes reconnection processing based on the identification information included in the reconnection request. The communication apparatus transmits an RRC Reestablishment Request message for connection to the IAB donor 103, to the IAB node 111 based on the identification information, for example. Upon receiving this message, the IAB node 111 transfers the message to the IAB donor 103. Note that, in a case where RRC Reestablishment Request messages are respectively received from a plurality of communication apparatuses, the IAB node 111 may multiplex the messages and transfer the multiplexed messages to the IAB donor 103. Upon receiving messages respectively from a plurality of communication apparatuses, for example, the IAB node 111 may extract a common portion, and transmit one message that includes the one common portion and individual portions for the respective communication apparatuses, to the IAB donor 103. Accordingly, it is possible to prevent a plurality of similar messages from being separately transmitted to the IAB donor 103, and to prevent wireless resources being unnecessarily used.

The IAB donor 103 receives the RRC Reestablishment Request messages via the IAB node 111. Note that, if a message in which RRC Reestablishment Request messages for a plurality of communication apparatus are multiplexed is received, the IAB donor 103 obtains information that enables the communication apparatus to be specified, from the message. The IAB donor 103 then requests the base station apparatus (the IAB donor 101) to which the IAB node 111 was connected most recently, to provide UE Contexts for the communication apparatuses, and obtains the UE Contexts. The IAB donor 103 transmits a Retrieve UE Context Request message to the IAB donor 101, and receives a Retrieve UE Context Response message from the IAB donor 101, thereby obtaining the UE Contexts for the communication apparatuses, for example. At this time, the IAB donor 103 may multiplex Retrieve UE Context Request messages for the plurality of communication apparatuses. Specifically, the IAB donor 103 may request the UE Contexts for the plurality of communication apparatuses, using one Retrieve UE Context Request message. Also, the IAB donor 101 may multiplex Retrieve UE Context Response messages for a plurality of communication apparatuses, and transmit one Retrieve UE Context Response message.

Upon receiving the UE Contexts of the plurality of communication apparatuses, the IAB donor 103 transmits RRC Reestablishment messages to the communication apparatuses based on the UE Contexts. The IAB donor 103 specifies, from each UE Context, a connection parameter that the communication apparatus used when the communication apparatus was connected to the IAB donor 101, and determines a connection parameter that is to be used when the communication apparatus is connected to the IAB donor 103, based on the specified connection parameter, for example. The IAB donor 103 then generates an RRC Reestablishment message that includes the determined connection parameter, and transmits the generated message to the terminal apparatus via the IAB node 111. Note that the IAB donor 103 may also multiplex RRC Reestablishment messages for the plurality of communication apparatuses to generate one message, and transmit the message to the IAB node 111. The IAB node 111 may then generate RRC Reestablishment messages for the respective terminal apparatus from the received message, and transmit the generated messages to the terminal apparatuses. As a result of such multiplexing, the number of messages that are transmitted/received between the IAB donor 103 and the IAB node 111 is reduced, and wireless resources can be effectively used.

RRC Reestablishment Complete messages are then transmitted from the respective terminal apparatuses to the IAB donor 103 via the IAB node 111, and RRC (Radio Resource Control) connection between the IAB donor 103 and the terminal apparatuses is established. Note that the IAB node 111 may multiplex the RRC Reestablishment Complete messages received from a plurality of communication apparatuses so as to generate one message, and transmit the generated message to the IAB donor 103. Also as a result of such multiplexing, it is possible to reduce the number of messages that are transmitted/received between the IAB donor 103 and the IAB node 111.

Note that FIG. 1 illustrates a case in which the IAB node 111 is directly connected to the IAB donor 101 or the IAB donor 103, but may also be connected to the IAB donor via another IAB node. In addition, the terminal apparatus 121 or the terminal apparatus 122 may be another IAB node. In addition, FIG. 1 shows only a small number of IAB donors, IAB nodes, and terminal apparatuses, but there may be a larger number of IAB donors, IAB nodes, and terminal apparatuses without loss of generality.

### Apparatus Configuration

Next, the configuration of the apparatuses that execute processing such as that described above will be described. FIG. 2 shows an exemplary hardware configuration of each of the apparatuses. The apparatus includes a processor 201, a ROM 202, a RAM 203, a storage apparatus 204, and a communication circuit 205, as an example. In the apparatus, for example, a computer-readable program that realizes the above-described functions of the apparatus, and is recorded in one of the ROM 202, the RAM 203, and the storage apparatus 204 is executed by the processor 201. Note that, the processor 201 may be replaced with one or more processors such as an application-specific integrated circuit (ASIC), Field Programmable Gate Arrays (FPGA), and a DSP (digital signal processor).

The processor 201 of the apparatus controls the communication circuit 205 so as to perform communication with a partner apparatus (an LAB donor, an IAB node, a terminal apparatus, or the like), for example. Note that FIG. 2 shows a schematic diagram in which the apparatus includes one communication circuit 205, but there is no limitation thereto. The IAB donor may include a communication circuit for communicating with an IAB node and a terminal apparatus, and a communication circuit for communicating with another IAB donor, for example. In addition, the IAB node may include a communication circuit for communicating with an IAB donor and a communication circuit for communicating with another IAB node and a terminal apparatus, for example.

FIG. 3 shows an exemplary functional configuration of an IAB node. The IAB node is constituted by a connection destination change processing unit 301 and a reconnection request unit 302, for example. Note that the IAB node is configured to be capable of performing functions of an ordinary IAB node in addition to these as a matter of course. In addition, a portion or the entirety of the functional configuration may be realized by the processor 201 executing a program stored in the ROM 202 or the storage device 204, for example. Moreover, dedicated hardware that realizes this functional configuration may be prepared. In addition, for example, the functional configuration in FIG. 3 may also be realized by a processor included in the communication circuit 205 executing a dedicated program. In addition, a portion of the functions in FIG. 3 may be omitted, or a function in FIG. 3 may be replaced with another function that has similar capability.

Upon receiving a handover instruction from an IAB donor connected to the IAB node, for example, the connection destination change processing unit 301 executes handover processing for changing a connection destination, namely an IAB donor. In accordance with receiving an RRC Reconfiguration message that includes a handover instruction from the IAB donor connected to the IAB node, for example, the connection destination change processing unit 301 transmits a random access preamble to an IAB donor that is a handover destination (or another IAB node connected to the IAB donor). The connection destination change processing unit 301 then receives a random access response, thereby establishing synchronization with the IAB donor that is a handover destination, and then establishing RRC connection. In addition, for example, if a random access response to the random access preamble could not be received, the connection destination change processing unit 301 may determine that it is not possible to establish connection to the IAB donor that is a handover destination, and execute processing for reconnection to another IAB donor. The connection destination change processing unit 301 transmits an RRC Reestablishment Request message to an IAB donor selected as a connection destination, for example. The connection destination change processing unit 301 then receives an RRC Reestablishment message from the IAB donor, and, in response, returns an RRC Reestablishment Complete message to the IAB donor. Accordingly, the connection destination change processing unit 301 can establish RRC connection to the IAB donor. The connection destination change processing unit 301 then executes setting such as establishment of an F1 interface in order to function as a relay apparatus that relays communication between the IAB donor that is a connection destination and terminal apparatuses.

If, for example, the connection destination change processing unit 301 fails in a handover to an IAB donor specified as a handover destination, and is connected to another IAB donor, the reconnection request unit 302 transmits a message requesting the communication apparatuses connected downstream of the IAB node in a state immediately before the change of the connection destination, namely an IAB donor, to execute processing for reconnection to the IAB donor that is a reconnection destination. The reconnection request unit 302 may add identification information of the IAB node or the IAB donor that is a reconnection destination, to an RRC Release message, for example, and transmit the message to the communication apparatuses. Also, if a communication apparatus is an IAB node, the reconnection request unit 302 may add the identification information of the IAB node or the IAB donor that is a reconnection destination to a BAP command, and transmit the BAP command to the communication apparatus, for example. Then, upon receiving RRC Reestablishment Request messages from the communication apparatuses, the reconnection request unit 302 (for example, multiplexes and) transmits the messages to the IAB donor that is a reconnection destination. Upon receiving, from the IAB donor that is a reconnection destination, (for example, multiplexed) RRC Reestablishment messages to the communication apparatuses, the reconnection request unit 302 transfers the messages to the communication apparatuses. Furthermore, upon receiving RRC Reestablishment Complete messages from the communication apparatuses, the reconnection request unit 302 (for example, multiplexes the messages, and) transmits the messages to the IAB donor that is a reconnection destination. Accordingly, RRC connection is established between the IAB donor that is a reconnection destination and the downstream communication apparatuses.

FIG. 4 shows an exemplar functional configuration of a communication apparatus connected downstream of the IAB node. The communication apparatus is constituted by a request receiving unit 401 and a reconnection processing unit 402, for example. Note that the communication apparatus is configured to be capable of performing functions of an ordinary communication apparatus (terminal apparatus or IAB node) in addition to these as a matter of course. In addition, a portion or the entirety of the functional configuration may be realized by the processor 201 executing a program stored in the ROM 202 or the storage device 204, for example. Moreover, dedicated hardware that realizes this functional configuration may be prepared. In addition, for example, the functional configuration in FIG. 4 may also be realized by a processor included in the communication circuit 205 executing a dedicated program. In addition, a portion of the functions in FIG. 4 may be omitted, or a function in FIG. 4 may be replaced with another function that has similar capability.

The request receiving unit 401 receives, from the upstream IAB node, a message that includes information such as identification information that enables the IAB node and the IAB donor that is a reconnection destination of the IAB node, to be specified, for example. This message may be an RRC Release message, for example. In addition, if the communication apparatus is an IAB node, the message may be a BAP command. The reconnection processing unit 402 executes processing for establishing reconnection to the IAB donor that is a reconnection destination of the IAB node, based on the information included in the message received by the request receiving unit 401. That is to say, the reconnection processing unit 402 transmits an RRC Reestablishment Request message to the IAB donor and receives a RRC Reestablishment message from the IAB donor, via the IAB node. The reconnection processing unit 402 then transmits an RRC Reestablishment Complete message to the IAB donor, and establishes RRC connection to the IAB donor.

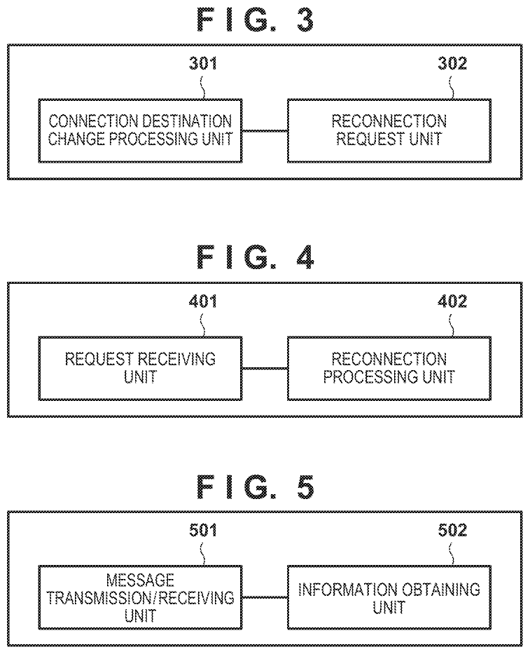

FIG. 5 shows an exemplary functional configuration of an LAB donor. The IAB donor is constituted by a message transmission/receiving unit 501 and an information obtaining unit 502, for example. Note that the IAB donor is configured to be capable of performing ordinary functions of an IAB donor in addition to these as a matter of course. In addition, a portion or the entirety of the functional configuration may be realized by the processor 201 executing a program stored in the ROM 202 or the storage apparatus 204, for example. In addition, dedicated hardware that realizes this functional configuration may be prepared. The functional configuration in FIG. 5 may also be realized by a processor included in the communication circuit 205 executing a dedicated program, for example. Some of the functions in FIG. 5 may be omitted, or a function in FIG. 5 may be replaced with another function that has similar capability.

The message transmission/receiving unit 501 transmits a control message to another apparatus, and receives a control message from another apparatus. The message transmission/receiving unit 501 receives an RRC Reestablishment Request message from a communication apparatus connected downstream of the IAB node to which the IAB donor has been reconnected, via the IAB node, for example. Also, the message transmission/receiving unit 501 transmits an RRC Reestablishment message to the communication apparatus, and receives an RRC Reestablishment Complete message. Note that the message transmission/receiving unit 501 may be configured to, in a case where a message in which information regarding a plurality of communication apparatuses is multiplexed is received, be capable of recovering the information regarding the plurality of communication apparatuses from the message, and multiplexing messages to be transmitted to the plurality of communication apparatuses so as to generate one message.

When the message transmission/receiving unit 501 receives an RRC Reestablishment Request message from a communication apparatus, the information obtaining unit 502 obtains the UE Context of the communication apparatus. The information obtaining unit 502 controls the message transmission/receiving unit 501 to transmit a Retrieve UE Context Request message in order to request that an IAB donor to which the IAB node was connected most recently provide the UE Context of the communication apparatus, for example. At this time, the message transmission/receiving unit 501 may multiplex messages for obtaining UE Contexts of a plurality of communication apparatuses, generate one Retrieve UE Context Request message, and transmit the message. The information obtaining unit 502 then obtains the UE Contexts of the communication apparatuses from a Retrieve UE Context Response message received by the message transmission/receiving unit 501. A configuration may be adopted in which a UE Context includes information regarding a connection parameter that the communication apparatus used, for example, and the IAB donor determines a connection parameter that is to be used after reconnection, based on the information, and the message transmission/receiving unit 501 transmits an RRC Reestablishment message that includes the connection parameter, to the communication apparatus.

### Flow of Processing

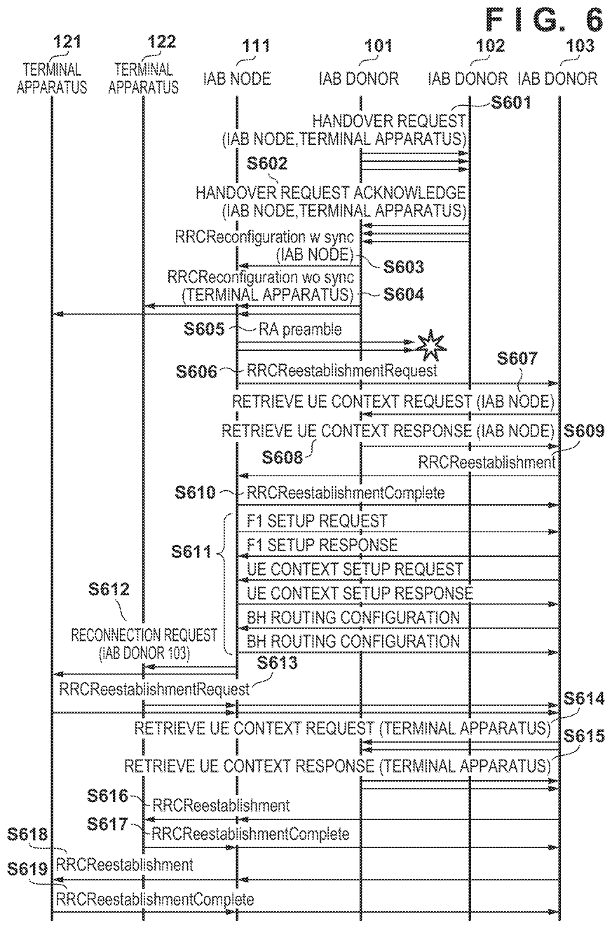

Next, an example of flow of processing that is executed by the wireless communication system will be described with reference to FIG. 6.

In this processing, first, the IAB donor 101 connected to the IAB node 111 determines that a handover of the IAB node 111 is to be performed, in accordance with deterioration in first wireless quality of a signal received by the IAB node 111 from the IAB donor 101, second wireless quality of a signal received by the IAB node 111 from the IAB donor 102 exceeding the first wireless quality by more than a predetermined level, or the like. The IAB donor 101 then specifies the communication apparatuses connected downstream of the IAB node 111, generates Handover Request messages for the apparatuses, and a Handover Request message for the IAB node 111, and transmits the messages to the IAB donor 102 that is a handover destination (step S601). The IAB donor 102 obtains information such as connection parameters that are being used by the apparatuses, from the Handover Request messages for the respective apparatuses. The IAB donor 102 then determines connection parameters to be used by the apparatuses after a handover, and the like, generates Handover Request Acknowledge messages for the respective apparatuses, the messages including the information, and transmits the messages to the IAB donor 101 that is a handover source (step S602).

Upon receiving the Handover Request Acknowledge messages, the IAB donor 101 generates RRC Reconfiguration messages for the IAB node 111 and the communication apparatuses connected downstream of the IAB node 111, based on the received messages, and transmits the messages to the IAB node 111 (steps S603 and S604). At this time, the RRC Reconfiguration message for the IAB node 111 may indicate that synchronization establishment processing such as random access processing is to be executed. On the other hand, the RRC Reconfiguration messages for the communication apparatuses connected downstream of the IAB node 111 may indicate that synchronization establishment processing such as random access processing is not to be executed. Note that, in FIG. 6, “w sync” indicates that synchronization establishment processing is necessary, and “wo sync” indicates that synchronization establishment processing is not necessary. Here, in FIG. 6, the IAB node 111 transfers the RRC Reconfiguration message for the downstream communication apparatuses, to the downstream communication apparatus. Accordingly, the downstream communication apparatuses complete handover processing.

Next, the IAB node 111 first attempts connection to the IAB donor 102 that is a handover destination. Specifically, the IAB node 111 transmits a random access (RA) preamble to the IAB donor 102, based on the RRC Reconfiguration message to the IAB node 111, in order to establish synchronization with the IAB donor 102 (step S605). Here, assume that, in this processing example, the IAB donor 102 cannot detect an RA preamble, and does not transmit an RA response. If the IAB node 111 cannot receive an RA response, and determines that a handover has failed, the IAB node 111 transmits an RRC Reestablishment Request message for reconnection with another IAB donor 103, to the IAB donor 103 (step S606). Upon receiving the RRC Reestablishment Request message from the IAB node 111, the IAB donor 103 transmits a Retrieve UE Context Request message for making a request to obtain the UE Context of the IAB node 111, to a base station apparatus (the IAB donor 101) to which the IAB node 111 was connected most recently (step S607). The IAB donor 103 then receives a Retrieve UE Context Response message from the IAB donor 101 (step S608), and obtains the UE Context of the IAB node 111 included in the message. The IAB donor 103 specifies a connection parameter that the IAB node 111 used when the IAB node 111 was connected to the IAB donor 101, using the obtained UE Context, and determines a connection parameter that enables communication that is similar to communication performed using the specified connection parameter, based on connection parameters that can be used by the IAB donor 103, for example. The IAB donor 103 then transmits an RRC Reestablishment message that includes the determined connection parameter and the like, to the IAB node 111 (step S609).

The IAB node 111 then transmits an RRC Reestablishment Complete message to the IAB donor 103 that is a reconnection destination (step S610), and establishes RRC connection to the IAB donor 103. The IAB node 111 then executes setting for operating as a relay apparatus with the IAB donor 103 (step S611). The IAB node 111 transmits a request (F1 Setup Request) message for establishing an F1 interface, to the IAB donor 103, and the IAB donor 103 transmits a response (F1 Setup Response) message to the request message, to the IAB node 111, for example. A UE Context Setup Request and a UE Context Setup Response are then transmitted/received, and routing setting (setting of relay path) of backhaul (BH) is executed.

When completing setting for operating as a relay apparatus, the IAB node 111 transmits a message requesting reconnection to the IAB donor 103, to the communication apparatuses (the terminal apparatus 121 and the terminal apparatus 122) connected downstream of the IAB node 111 (step S612). Each of the communication apparatuses transmits an RRC Reestablishment Request message to the IAB node 111 based on this message, in order to request reconnection to the IAB donor 103, and the IAB node 111 transfers the messages to the IAB donor 103 (step S613).

Upon receiving the RRC Reestablishment Request messages from the communication apparatuses (the terminal apparatus 121 and the terminal apparatus 122) connected downstream of the IAB node 111, the IAB donor 103 requests the IAB node 101 to which the IAB node 111 was connected most recently, for the UE Contexts of the communication apparatus, and obtains the UE Contexts (steps S614 and S615). The IAB donor 103 then transmits an RRC Reconfiguration message to the communication apparatuses (the terminal apparatus 121 and the terminal apparatus 122), based on the obtained UE Contexts (steps S616 and S618). Note that this RRC Reconfiguration message may indicate that the connection destination, namely the base station apparatus has been changed to the IAB donor 103. In addition, this RRC Reconfiguration message may include a connection parameter that is to be used by the communication apparatus, and that is selected from connection parameters that can be used by the IAB donor 103, based on each of the UE Contexts. Note that the RRC Reconfiguration message includes information regarding the connection parameters, and does not need to include information indicating the IAB donor 103. The communication apparatuses change settings such as the connection parameters based on this message, return an RRC Reconfiguration Complete message to the IAB donor 103 (steps S617 and S619), and end the processing.

Note that, if the terminal apparatus 121 or the terminal apparatus 122 is an IAB node, processing such as processing of steps S611 is executed between the IAB node and the IAB donor 103 in order for the IAB node to operate as a relay apparatus. At this time, for example, in step S613, the RRC Reestablishment Request message is transmitted from a communication apparatus connected downstream of the IAB node, to the IAB donor 103. That is to say, if another IAB node is connected downstream of the IAB node 111, after RRC connection is established between the IAB node and the IAB donor 103, the processing of step S611 is executed, and a communication apparatus connected on the further downstream side attempts establishment of reconnection to the IAB donor 103.

With such a procedure, the communication apparatuses (the terminal apparatus 121 and the terminal apparatus 122) connected downstream of the IAB node 111 do not need execute processing such as cell search, after reconnection processing of the IAB node 111. Thus, it is possible to shorten a period during which the communication apparatuses cannot execute communication due to a switch of the connection destination of the IAB node 111.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A relay apparatus that relays communication between a base station apparatus and a communication apparatus that is connected to the base station apparatus, the relay apparatus comprising:
one or more processors; and
one or more memories that store a computer-readable instruction for causing, when executed by the one or more processors, the relay apparatus to:
transmit, in a case where the relay apparatus is connected to another base station apparatus, a message requesting connection with the other base station apparatus, to the communication apparatus.

2. The relay apparatus according to claim 1, wherein
the relay apparatus transmits, to the communication apparatus, the message that includes information that enables the relay apparatus or the other base station apparatus to be specified.

3. The relay apparatus according to claim 1, wherein
the relay apparatus transmits an RRC message as the message.

4. The relay apparatus according to claim 1, wherein
in a case where the communication apparatus is another relay apparatus, the relay apparatus transmits a Backhaul Adaptation Protocol (BAP) command as the message.

5. The relay apparatus according to claim 1, wherein
in a case where the relay apparatus is connected to the other base station apparatus on the occasion of a failure in a handover from the base station apparatus, the relay apparatus transmits the message to the communication apparatus.

6. A communication apparatus comprising:
one or more processors; and
one or more memories that store a computer-readable instruction for causing, when executed by the one or more processors, the communication apparatus to:
receive, in a case where a relay apparatus that relays communication between a base station apparatus and the communication apparatus is connected to another base station apparatus, a message requesting connection with the other base station apparatus, from the relay apparatus; and
execute processing for connection to the other base station apparatus via the relay apparatus based on the message.

7. The communication apparatus according to claim 6, wherein
the message includes information that enables the relay apparatus or the other base station apparatus to be specified, and
the communication apparatus executes the connecting processing based on the information.

8. The communication apparatus according to claim 6, wherein
the message is an RRC message.

9. The communication apparatus according to claim 6, wherein
in a case where the communication apparatus is an apparatus that relays communication between the relay apparatus and another communication apparatus, the communication apparatus receives a Backhaul Adaptation Protocol (BAP) command as the message.

10. The communication apparatus according to claim 6, wherein
the message is transmitted from the relay apparatus in a case where the relay apparatus is connected to the other base station apparatus on the occasion of a failure in a handover from the base station apparatus.

11. A control method that is executed by a relay apparatus that relays communication between a base station apparatus and a communication apparatus that is connected to the base station apparatus, the method comprising:
transmitting, in a case where the relay apparatus is connected to another base station apparatus, a message requesting connection with the other base station apparatus, to the communication apparatus.

12. A control method that is executed by a communication apparatus, comprising:
receiving, in a case where a relay apparatus that relays communication between a base station apparatus and the communication apparatus is connected to another base station apparatus, a message requesting connection with the other base station apparatus, from the relay apparatus; and
executing processing for connection to the other base station apparatus via the relay apparatus based on the message.

13. A non-transitory computer-readable storage medium that stores a program for causing a computer included in a relay apparatus, which relays communication between a base station apparatus and a communication apparatus that is connected to the base station apparatus, to:
transmit, in a case where the relay apparatus is connected to another base station apparatus, a message requesting connection with the other base station apparatus, to the communication apparatus.

14. A non-transitory computer-readable storage medium that stores a program for causing a computer included in a communication apparatus to:
receive, in a case where a relay apparatus that relays communication between a base station apparatus and the communication apparatus is connected to another base station apparatus, a message requesting connection with the other base station apparatus, from the relay apparatus; and
execute processing for connection to the other base station apparatus via the relay apparatus based on the message.
